(19) United States
(12) Patent Application Publication
(10) Pub. No.: US 2011/0301515 A1
(43) Pub. Date: Dec. 8, 2011

(54) Octave exclusion signal generating method

(76) Inventor: Richard H. Lee, Laguna Niguel, CA (US)

(21) Appl. No.: 12/802,421

(22) Filed: Jun. 7, 2010

(51) Int. Cl. A61H 23/02

(52) U.S. Cl. 601/47

(57) ABSTRACT

In accordance with this invention, a method is described that produces signals with reduced spectral density in a selected note range at multiple octaves.

### CROSS REFERENCE TO RELATED APPLICATIONS

Therapy devices that deliver signals are very common, though devices that deliver signals comprising bands of frequency are considerably less common. U.S. Pat. No. 6,461,316, CHAOS THERAPY METHOD AND DEVICE, invented by and registered to me describes a device that produces non-linearly varying signals produced by means of digitally filtering a string of random numbers. U.S. Pat. No. 6,770,042, THERAPEUTIC SIGNAL COMBINATION, also invented by and registered to me describes a device that combines signals with non-linear frequency variation to produce a composite signal. U.S. Pat. No. 7,419,474, Non-Linear Therapy signal Synthesizer discloses a method for producing signals one arc at a time by incrementing the phase angle of a sine function, then combining the produced frequency bands into longer signals. Those patents describe relevant prior art to this patent and are included as reference and as background to the specification of this patent application.

### FEDERALLY SPONSORED RESEARCH

Not Applicable

### SEQUENCE LISTING OR PROGRAM

GoldWave, a freeware program available for download on the web was used to produce the principal embodiment of this invention, though many signal processing, sound editing and other methods might be used. Common functions within that program are used to manipulate signals to produce a novel class of therapeutic signals, those which have reduced power spectral density in frequency bands of the same note range on multiple octaves. Other methods might be used, but this is the one that was used in the principal embodiment.

### BACKGROUND OF THE INVENTION

1. Field of Invention

This invention relates to the creation and delivery of signals comprising frequency bands of high power spectral density, and excluding frequency bands of low power spectral density that comprise a set note range that repeats at multiple octaves. One of the purposes of these signals is to provide relief from physical and emotional pain.

2. Prior Art

Several patents, including those listed above, provide related prior art. Here are additional references which, while related to signal production, do not disclose, imply, or predict the claims of this patent application.

2002/0055762 describes a device that applies electrical pulses the frequency of which sweeps from less than 4 Hz to above 10 Hz. over a period of more than 6 seconds. This signal can be automatically varied in response to a signal received from a recipient. This does not exclude repeating bands of frequency that comprise a set note range that repeats at multiple octaves.

US 2001/0031999 describes combining a mixture of sine waves to generate an arbitrary wave form. This technique, an application of inverse Fourier transform used here to synthesize a pulse for pacemaker applications, provides a repeating pattern, a repeating pulse wave, differentiating it from this invention. Inverse Fourier synthesis, if employed differently, might be employed to create a signal that excludes bands of frequency that comprise a set note range that repeats at multiple octaves. However, no specific method was disclosed that would accomplish that.

U.S. Pat. No. 6,188,929 describes a device that delivers pulses of specified frequency, amplitude, and dwell time. It offers a system by which a memory location is randomly selected, delivering a pulse of random frequency, amplitude and dwell time. This method, selecting random frequency, amplitude, and dwell time to produce pulses, again, does not disclose creating a signal that excludes bands of frequency that comprise a set note range that repeats at multiple octaves.

The key lacking of all these methods for producing signals, from the perspective of the current invention, is that they do not produce signals with reduced power spectral density in specified note ranges at multiple octaves.

### OBJECTS AND ADVANTAGES

This invention involves combining signals of specific frequency composition for therapy or vibrational processing. An easy way to understand the frequency composition of these signals is that, in one embodiment, they exclude a continuous frequency band within an octave at multiple octaves between the notes of G, A, B, and C, and thus contain signals with higher power spectral density on selected octaves (like two adjacent octaves) between the notes C, D, E, F, and G. A full octave range runs from one frequency to double that frequency, or from one note to that same note at the next higher octave.

To my knowledge, there is no equipment on the market, nor are there are any patents that disclose eliminating specified frequency bands at multiple octaves to produce signals for therapy or any other purpose.

While a preferred embodiment excludes the approximate range of frequencies between the notes G, A, B, and C, which is effective for most people most of the time, in some cases, excluding other ranges like is likely to be most effective for different processes. In addition, the width of the excluded range can vary. The width can be quantified as follows: Highest and lowest frequencies of excluded range within the octave are HEF and LEF. Thus the width of the excluded range can be defined as (HEF−LEF)/LEF×100%. This Width must always fall between 0 and 100% the width of an octave. Since the objective of this embodiment is to produce a signal that is applicable to a broad range of people and/or conditions, excluding the range between G and C was selected as most generally suitable.

The term “excluding” is used in this patent application to mean substantially reducing the power spectral density (PSD) of a signal within the “excluded” range compared to the included range. Power spectral density is power as a function of frequency and is measured in such units as watts/Hz. It is not practical to entirely eliminate all energy in a particular frequency range when dealing with non linear and randomly varying signals, though greater attenuation is preferred with a signal consisting of discrete frequencies and linearly varying signals like those with sweeping frequency. All real-world signals will include some power spectral density in the excluded range. The method of this invention can be applied to signals made up of discrete frequencies and linearly varying frequencies quite easily by leaving out the discrete frequencies or sweep range that fall within the excluded range. However this method is more effective if the beat frequencies that result from interaction of bands at multiple wavelengths are filtered out.

This method can also be applied to music. However, excluding individual notes does not necessarily eliminate a significant portion of the excluded band so excluding notes in music is not, by itself, an application of this method. Filtering of music to exclude undesired ranges at multiple octaves is a practical application of this method. A less practical application of this method would be the meticulous exclusion of all sounds within the excluded range on multiple octaves, including notes, voices, and percussive tones. While this meticulous exclusion method will be somewhat effective, it is far more practical to filter the music so as to exclude the undesired bands. The best way to produce music according to this method would probably be first to exclude notes to the extent possible, then to filter the resulting music. One difference between the signals produced by this frequency band exclusion method and signals created by combining individual notes is that notes are sinusoidal signals of constant frequency, so music created by the “exclude note” method plays one series of notes for a period of time, then changes to another series of notes and the method of this invention is generally applied to signals of constantly varying frequency. Another factor is that, whenever you combine notes, such as a chord, you create a host of beat frequencies as the difference between the frequency of each two notes and the sum the frequencies of each two notes become frequencies present in the music. Voice, percussion, and many kinds of instruments, unless very carefully controlled, will not produce just individual notes, but rather, produce more broad spectrum frequency activity.

It is easiest to describe the signals that are the object of this invention in terms of musical notes, because they can so clearly define the limits of an exclusion band on multiple octaves, and thus illustrate the concept of “repeating frequency bands at multiple octaves” as it is intended in the patent application. Clarity can also be offered from an example of the signal that results when all frequencies between and around 50 Hz and 60 Hz and the same note range at other octaves (which is approximately the range between G and C) are excluded from a signal. This may suggest that one of the mechanisms for the therapeutic effectiveness of these frequency bands might be the reduction of rhythms in the body in the 50 Hz and 60 Hz range. These signals can be measured in Earth's magnetic field everywhere in the world because of the dominance of electrical power distribution. Further, they can entrain our body's natural rhythms, causing stress and pain and exacerbating health problems. This would imply that applying signals below and above this range, that exclude this range, might draw the vibration of our bodies out of entrainment with 50 Hz and 60 Hz. (It is not claimed that reducing the entrainment of 50 Hz/60 Hz power is the reason for the effectiveness of this invention. Rather, this is simply a an illustration of how this frequency band exclusion method might be effective.) Excluding frequencies within this range of 50 to 60 Hz at multiple octaves would give us allowed bands within 30 to 50 Hz, below the specified disallowed range, and within 60 to 90 Hz, above this range, which would entrain rhythms away from the 50-60 Hz range. By repeatedly dividing by or multiplying the above signal repeatedly by 2, one can create signals including many desired ranges such as 0.09375 to 1.5625 Hz, 480 to 740 Hz and so on. A signal made up of the approximate bands of 15-25 Hz and 30-50 Hz is also a principal embodiment of this invention in that it was found to be effective for therapy. It may be desirable to widen or narrow the excluded range at different octave ranges depending on such factors as degree of attenuation of the undesired signal, the specific effect desired, and the specific environmental signals that habitually entrain the body.

The novelty of this invention is first that it excludes specific note ranges, or frequency ranges in multiple octaves to produce therapeutic signals that can be used to promote health, healing, and well being and influence commercial, industrial, and agricultural processes. In addition, this method can be applied to spaces occupied by people, plants, and processes. More specifically, by including two or more frequency bands that are directly above and directly below an excluded note range the resulting signal tends to attenuate the excluded note range in the rhythms of any object or body, including the human body. Frequencies of vibration within the body are reduced by including adjacent ranges that entrain the body's vibrational energies away from the undesired range.

### SUMMARY

In accordance with this invention, a method is described that produces signals with reduced spectral density in specified note ranges at multiple octaves.

### DRAWINGS

FIG. 1 shows a process by which an input signal (10) is converted into a signal (50) that is a principal object of this invention.

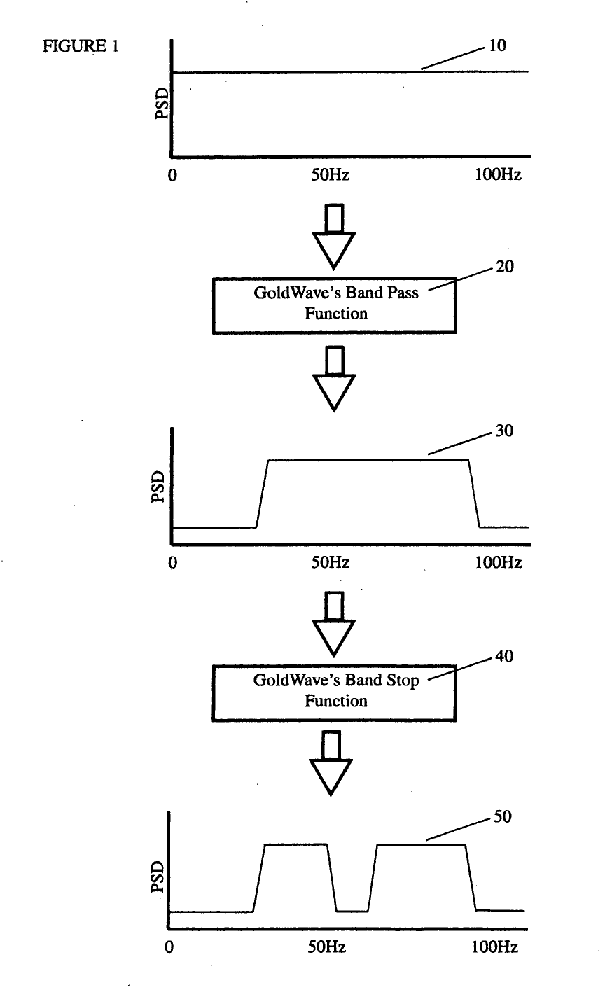

A signal (50) that comprises a principal embodiment of this invention was created using the popular freeware GoldWave available as a download on the internet, though it might have been created by a wide variety of methods including those disclosed in the prior art patents referred to above. An input signal (10) might be most any signal that includes the desired frequencies across the desired range. This includes such signals as white noise, pink noise, sweeps, pulses, music, and the spoken voice, which are loaded into GoldWave. In this case, signal (10) is white noise which, for the sake of simplicity, in FIG. 1 is represented with uniform distribution of power spectral density (PSD). FIG. 1 shows a spectrogram of signal (10) showing uniform spectral power density from 1 to 100 Hz. Signal (10) is then filtered by GoldWave's band pass function (20) with band pass limits set to 32 and 88 Hz. The resulting intermediate signal (30) shows reduced power spectral density below 32 Hz and above 88 Hz. Signal(30) is then filtered with GoldWave's notch filter (40) with limit frequencies of 48 Hz and 62 Hz. The resulting signal (50) has relatively little power spectral density in the frequency ranges below 30 Hz, between 50 and 60 Hz, and above 90 Hz. This is a principal example of an embodiment of this invention. Signals such as signal (50) are easily delivered by a wide variety of equipment available on the market, and by the methods disclosed in my previous patents which describe methods of producing signals that vary non-linearly and of applying them therapeutically to the body. Also, the signals that are the object of this invention can be combined with other signals with reduced power spectral density in the same excluded ranges, to create more complex signals.

### CONCLUSIONS, RAMIFICATIONS, AND SCOPE

The challenge of developing this invention was to discover and test the specific bands of signals described in this disclosure. It is relatively easy to produce these signals. Methods might include digital synthesis and digital filtration methods disclosed in my previous patents specified in the first section of this patent application, and a variety of other methods.

While the principal embodiment of this invention are signals that exclude the range between G and C, or octave multiples (and lower octaves) of 50 Hz to 60 Hz, Signals produced by this method in much higher and lower frequency ranges have been tested, and even broader applications are anticipated. In addition signals that have wider or narrower exclusion bands, or which have exclusion bands in ranges other than G to C. While signals excluding the G to C range appear effective at reducing anxiety, stress and pain, signals that exclude the general range between C to E tend to get people more into problem solving, and signals that exclude E to G, in some cases, help people to be more accepting of their environment. Thus signals with differing repeating exclusion bands will have different applications. Depending on application, the width of the included or excluded band might vary from octave to octave. It is also anticipated that, while the embodiment described above includes two included bands, and thus defines one excluded band between the two included bands, and one edge of each of two excluded bands, both below and above the included bands, it would be possible to create signals within this invention by attenuating two exclusion bands, with more or fewer partial inclusion bands or partial excluded bands, or with included or excluded bands that are more than an octave apart, or where the excluded bands are not in adjacent octaves.

It is also possible to create the signals in a variety of ways, including such methods as starting with a signal in the included range, then doubling the frequency of that signal and adding it to the original signal. This method might include post filtering to remove beat frequencies, and breaking the signal into short segments before doubling each segment. Another method might be the prior art method of creating a signal by incrementing a sine function, though, unless carefully done, this might also require post filtering to attenuate the exclusion bands.

These signals might be employed in a wide variety of vibrational processing applications, including, as examples, human and animal care, agriculture, and crystal formation in industrial processes. Many other uses for these signals are likely to be discovered.

What is claimed is:

1. Method of providing a signal to an object comprising a signal generating means and a signal delivery means, comprising the steps of:
a. Said signal generating means excludes a band of frequency within an octave range on a plurality of octaves,
b. Said signal deliver means delivers said signal to said object.

2. The method of claim 1 wherein said signal generating means excludes a plurality of bands of frequency on each of said plurality of octaves.

3. The method of claim 1 wherein said signal generating means excludes said band of frequency by means comprising filtering to exclude said band of frequency

4. The method of claim 1 wherein said signal generating means combines said signal with excluded band of frequency with a second signal, to produce a combined signal, and wherein said combined signal is delivered to said object by said signal delivery means.

5. The method of claim 1 wherein the width of said excluded band of frequencies varies from octave to octave.

6. The method of claim 1 wherein the width of said excluded band of frequencies comprises an approximate note range including the notes G, A, B, and C, and the frequencies that lie between these notes.

7. The method of claim 1 wherein the frequency of said signal varies non-linearly.

8. The method of claim 1 wherein said object is selected from a group comprising; a living being, an occupied space, an industrial process, and a commercial process.

c. The method of claim 1 wherein said excluded band of frequencies comprises a band of frequency less than 95% of said octave range.

9. The method of claim 9 wherein said signal generating means excludes a plurality of bands of frequency on each of said plurality of octaves.
